(19) United States
(12) Patent Application Publication
(10) Pub. No.: US 2023/0090452 A1
(43) Pub. Date: Mar. 23, 2023

(54) APPARATUS FOR MANAGING DENTAL HYGIENE

(71) Applicant: Alexis Nicole Clark, Brandon, FL (US)

(72) Inventor: Alexis Nicole Clark, Brandon, FL (US)

(21) Appl. No.: 17/821,078

(22) Filed: Aug. 19, 2022

Related U.S. Application Data
(60) Provisional application No. 63/245,900, filed on Sep. 19, 2021.

(51) Int. Cl. A61C 15/04; A46B 15/00

(52) U.S. Cl. CPC A61C 15/043; A46B 15/0055; A46B 2200/1066

(57) ABSTRACT

A smart dental hygiene that dispenses oral hygiene products including toothpaste, mouthwash, and dental floss is disclosed. The apparatus includes a casing comprising a first container for storing toothpaste, a second container for storing mouthwash, and the third container for storing dental floss. A first dispenser may be connected to the first container for enabling dispensing of toothpaste. A second dispenser may be connected to the second container for enabling dispensing of mouthwash. A third dispenser may be connected to the third container for enabling dispensing of dental floss. Furthermore, a microcontroller communicatively connected to the plurality of sensors is provided. The microcontroller may analyse the data collected by a plurality of sensors to determine a plurality of usage factors including quantity of toothpaste, mouthwash and dental floss dispensed during each dispensing action, amount of toothpaste, mouthwash and dental floss remaining in the containers, and the like.

### CROSS-REFERENCE TO RELATED APPLICATIONS

This application is a continuation application of U.S. Non-Provisional patent application Ser. No. ______—entitled, “SMART PASTE” filed Sep. ______, 2021.

### FIELD OF INVENTION

The present invention relates generally to dental hygiene devices. More particularly, the present invention relates to a smart dental hygiene product dispenser.

### BACKGROUND OF THE INVENTION

Dental hygiene refers to the practise of keeping the mouth, teeth, and gums clean and healthy to prevent diseases and also to protect teeth. Dental hygiene and oral health are often taken for granted but are essential parts of our everyday lives. Tooth decay or cavities are a common problem for people of all ages. For children, untreated cavities can cause pain as well as poor appearance. The problems related to teeth may affect the quality of life. The primary reason for most of the problems associated with tooth are due to the lack of cleanliness. In the absence of parents, the children may skip brushing their tooth at morning as well as at night. This create severe dental problems.

Toothpaste has a significant role in preventing tooth decay. The fluoride content present in the toothpaste may mix with saliva in mouth and protect teeth. The fluoride teams up with calcium and phosphate present in the enamel of tooth to create the most powerful defence system to prevent cavities from forming. Various disadvantages have been observed with regard to manually squeezing toothpaste from a collapsible tube in that the tube sometimes becomes badly twisted so as to make it difficult to squeeze the maximum amount of toothpaste out of said collapsible tube. Furthermore, the tube sometimes becomes cracked and the toothpaste oozes out of the collapsible tube.

Moreover, the toothbrushes need to be maintained, so they can remove plaque to keep teeth and gums healthy. Toothbrush storage is vital for maintaining cleanliness of tooth and in oral care. The toothbrush after use must be dried and keep in an open atmosphere to prevent bacteria and one must not share the toothbrush even with in a family. There may be chances to unintentionally swap toothbrush by children in the family. It may affect the oral hygiene of children.

U.S. Pat. No. 6,719,169B1 discloses a toothpaste dispensing and tube-storing unit that can neatly store multiple tubes of toothpaste in separate compartments and easily and efficiently be used to dispense toothpaste from the tubes. The unit can hold one or more toothpaste tubes, as well as several toothbrushes. Each compartment is open at the top and bottom ends and has a spring-loaded pressure squeeze-bar assembly mounted inside and near the bottom of the compartment. The front of each compartment has an open slot extending from the top opening to near the bottom of the unit for accessing a tube of toothpaste. The unit can be mounted on the wall for easy access. The toothpaste tube is inserted, cap end up, from the top of the compartment with the bottom end of the tube being inserted between two spring-loaded pressure squeeze-bars. When the bottom end of a tube is pulled downward, toothpaste is dispensed from the open top of the tube by means of pressure applied by the squeeze-bars. The pressure squeeze-bar mechanism will allow the tube to be squeezed flat, thereby allowing practically all of the toothpaste to be removed from a tube. In use, the cap is removed from one of the tubes and the bristles of a toothbrush are held over the tube opening with one hand. The bottom end of the tube is then pulled downward with the other hand, thereby dispensing toothpaste out of the tube on to the brush bristles. Furthermore, a stop guide means can be added to allow the tube to be pulled down a constant distance in order to dispense an equal amount of toothpaste each time the dispenser is used.

U.S. Pat. No. 6,845,883B2 discloses a toothpaste dispenser capable of dispensing individual quantity controlled amounts of toothpaste in a sanitary manner without the possibility of cross contamination. The dispenser includes an elongated strip having a plurality of one time use sachets formed integrally therewith, each sachet containing a measured quantity of toothpaste therein suitable for a single use. The strip is provided with weakened portions so that individually numbered sachets may detached from the strip. The individual sachets may be opened after they are detached from the strip and the contents may be squeezed out. In addition, the sachets may be color coded which is useful when the usage of more than one child is being monitored. A parent may monitor the usage of the individual sachets by reviewing the number, and if more than one child is in the family, the color of the emptied sachet.

U.S. Pat. No. 8,033,428B1 discloses an apparatus and method for dispensing toothpaste whereby a user may depress a depressor to extract a pre-determined quantity of toothpaste from a tube of toothpaste. The present invention includes a toothpaste dispenser body forming a radius resiliently and integrally securing together a substantially flat first coextensive member and a substantially flat second coextensive member. The second coextensive member may comprise a downward first curvature towards the first coextensive member and an upward second curvature away from the first coextensive member. The second coextensive member comprises a depressor comprising resilient material. The radius may be used to contain and roll the portion of the toothpaste tube that has been evacuated of toothpaste, thereby allowing the second coextensive member to remain in contact with the filled portion of the toothpaste tube.

U.S. Pat. No. 9,907,391B2 discloses a combination toothbrush and toothpaste dispenser device including a caddy that accepts tube of toothpaste and guides an integral toothpaste squeezer along a predetermined track. The squeezer is generally wedge-shaped and may be moved parallel and/or inwardly to the axis of the caddy. A modular and detachable toothbrush head mates with the caddy and includes a shaft with a central bore for delivering toothpaste to the toothbrush bristles. A refresh cup is further supplied to store and protect the combination device while not in use.

US20070029349A1 discloses a toothpaste dispenser device that has an upright elongated main housing base having a bottom and at least one side wall, and having and a tube insert opening for inserting a tube therein, and a dispensing outlet located on the side wall. A male receiving inlet stem is adapted for receiving the inside neck of an inverted, uncapped toothpaste tube thereon and has a plurality of different outside diameters in an increasing size with descending position, capable of receiving a plurality of different size tube necks with different inside diameters. A dispensing conduit and one way valves are functionally connected to the inlet and to the outlet, and a spring-biased push rod is provided for pumping.

While the prior arts focus primarily on dispensing toothpaste, there is a need for an apparatus that manages multiple dental hygiene products including toothpaste, toothbrush, mouthwash, dental floss, and the like. Moreover, it will be advantageous to provide an apparatus that keeps track of the usage patterns of individuals using the dental hygiene products.

### SUMMARY OF THE INVENTION

In light of the disadvantages of the prior art, the following summary is provided to facilitate an understanding of some of the innovative features unique to the present invention and is not intended to be a full description. A full appreciation of the various aspects of the invention can be gained by taking the entire specification and drawings as a whole.

Embodiments disclosed here proposes a smart dental hygiene kit. The apparatus may allow dispensing oral hygiene products including toothpaste, mouthwash, and dental floss. The apparatus may further allow users to store one or more toothbrushes. The primary component of the apparatus includes a casing comprising a first container for storing toothpaste, a second container for storing mouthwash, and the third container for storing dental floss. A first dispenser may be connected to the first container for enabling dispensing of toothpaste. A second dispenser may be connected to the second container for enabling dispensing of mouthwash. A third dispenser may be connected to the third container for enabling dispensing of dental floss. Furthermore, one or more pumps and/or motors may be provided for enabling dispensing of toothpaste, mouthwash, and dental floss via the first, the second, and the third dispensers. A plurality of sensors configured to collect data related to amount of toothpaste, mouthwash, and dental floss dispensed by the apparatus during each dispensing action and timestamp of each dispensing action may be provided within the apparatus. Furthermore, a microcontroller communicatively connected to the plurality of sensors is provided. The microcontroller may analyse the data collected by the plurality of sensors to determine a plurality of usage factors. The usage factors may include quantity of toothpaste, mouthwash and dental floss dispensed during each dispensing action, amount of toothpaste, mouthwash and dental floss remaining in the containers, and the like. The microcontroller may communicate the plurality of usage factors to one or more users via a combination of display screen and a speaker provided on the casing or via an electronic device communicatively coupled to the apparatus.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures. The abovementioned embodiments and further variations of the proposed invention are discussed in further in the detailed description.

### BRIEF DESCRIPTION OF THE DRAWINGS

FIG. 1 is an exemplary depiction of the front view of the apparatus for managing dental hygiene with its front lid in a closed configuration according to the embodiments of the present disclosure.

FIG. 2 is an exemplary depiction of the front view of the apparatus for managing dental hygiene with its front lid in an open configuration according to the embodiments of the present disclosure.

FIG. 3 is another exemplary depiction of the front view of the apparatus for managing dental hygiene with its front lid in an open configuration with the mouthwash container removed according to the embodiments of the present disclosure.

FIGS. 4 & 5 are exemplary isometric views of the apparatus for managing dental hygiene according to the embodiments of the present disclosure.

FIG. 6 is an exemplary isometric view of the apparatus for managing dental hygiene with the front lid in an open configuration according to the embodiments of the present disclosure.

FIG. 7 is a left side view of the apparatus for managing dental hygiene according to the embodiments of the present disclosure.

FIG. 8 is a right side view of the apparatus for managing dental hygiene according to the embodiments of the present disclosure.

FIG. 9 is a rear side isometric view of the apparatus for managing dental hygiene according to the embodiments of the present disclosure.

The drawings described herein are for illustration purposes only and are not intended to limit the scope of the present subject matter in any way.

### DETAILED DESCRIPTION OF THE INVENTION

In the following description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limited sense.

The specification may refer to “an”, “one” or “some” embodiment(s) in several locations. This does not necessarily imply that each such reference is to the same embodiment(s), or that the feature only applies to a single embodiment. Single feature of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present disclosure provides a device that may be used as a dental hygiene apparatus. In the foregoing sections of the present disclosure, the apparatus may be referred as “dental hygiene kit” or “dental kit” interchangeably depending on the context of the sentence. The terms used herein does not limit the scope of the present disclosure.

According to the embodiments of the present disclosure, a smart dental hygiene kit is proposed. The apparatus may allow dispensing oral hygiene products including but not limited to toothpaste, mouthwash, dental floss, and the like. The apparatus may further allow users to store one or more toothbrushes on the slots provided within the body of the apparatus. The primary component of the apparatus includes a casing with a hollow inner body. The casing may have a front lid on the front side that may be attached to the body of the casing via one or more hinges. The bottom portion of the casing may have a pair of side lids for securely storing one or more toothbrushes within the slots provided on the bottom portion of the casing.

The apparatus further comprises a first container for storing toothpaste, a second container for storing mouthwash, and the third container for storing dental floss. The shape and form factor of the containers may be different since each one of them store different kind of product. Each of the containers may have an opening that may be used for refilling. Alternatively, the containers may be replaced by fresh containers once the products stored within the containers are exhausted.

A first dispenser may be connected to the first container for enabling dispensing of toothpaste. A second dispenser may be connected to the second container for enabling dispensing of mouthwash. A third dispenser may be connected to the third container for enabling dispensing of dental floss. One or more pumps and/or motors may be provided for enabling dispensing of toothpaste, mouthwash, and dental floss via the first, the second, and the third dispensers.

In addition, a plurality of sensors configured to collect data related to amount of toothpaste, mouthwash, and dental floss dispensed by the apparatus during each dispensing action and timestamp of each dispensing action may be provided within the apparatus. Furthermore, a microcontroller having a processor and a memory may be communicatively connected to the plurality of sensors. The microcontroller may analyse the data collected by the plurality of sensors to determine a plurality of usage factors. The usage factors may include quantity of toothpaste, mouthwash and dental floss dispensed during each dispensing action, amount of toothpaste, mouthwash and dental floss remaining in the containers, and the like.

The microcontroller may also monitor and identify each user based on one or more biological factors or by means of a toothbrush assigned to each user. The number of times a user uses the dental kit and the products provided within the kit, the quantity of products dispensed during each action, the amount of time the user uses each one of the dental products, and the like, are monitored to come up with scores and recommendations for each user. The microcontroller may communicate the plurality of usage factors including scores and recommendations to one or more users via a combination of display screen and a speaker provided on the casing of the apparatus or via an electronic device communicatively coupled to the apparatus.

Processor(s) provided in the microcontroller may include but are not limited to, one or more digital signal processors (DSPs), one or more microprocessor, one or more special-purpose computer chips, one or more field-programmable gate arrays (FPGAs), one or more application-specific integrated circuits (ASICs), one or more computer(s), various analog to digital converters, digital to analog converters, and/or other support circuits. Processor(s) thus may also include the functionality to encode messages and/or data or information. Processor(s) may include, among other things, a clock, an arithmetic logic unit (ALU) and logic gates configured to support the operation of processor(s). Further, the processor(s) may include functionality to execute one or more software programs, which may be stored in the memory or otherwise accessible to processor(s).

Memory associated with the microcontroller may store any number of pieces of information, and data, used by the system to implement the functions of the system. Memory may include, for example, volatile memory and/or non-volatile memory. Examples of volatile memory may include but are not limited to volatile random-access memory (RAM). The non-volatile memory may additionally or alternatively comprise an electrically erasable programmable read-only memory (EEPROM), flash memory, hard drive, and the like. Some examples of the volatile memory include, but are not limited to, dynamic RAM, static RAM, and the like. Some example of the non-volatile memory includes, but are not limited to, hard disks, magnetic tapes, optical disks, programmable read-only memory, erasable programmable read-only memory, electrically erasable programmable read-only memory, flash memory, and the like. Memory may be configured to store information, data, applications, instructions, or the like for enabling the system to carry out various functions in accordance with various example embodiments. Additionally, or alternatively, the memory may be configured to store instructions which when executed by processor(s) cause the smart burglar detection unit to behave in a manner as described in various embodiments.

In one implementation, the network associated with the microcontroller for communicating with the connected electronic device(s) may be a wireless network, a wired network, or a combination thereof. The network may be implemented as one of the several types of networks, such as an intranet, local area network (LAN), wide area network (WAN), the Internet, and the like. The network may either be a dedicated network or a shared network. The shared network represents an association of the several types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network may include a variety of network devices, including routers, bridges, servers, computing devices, storage devices, and the like.

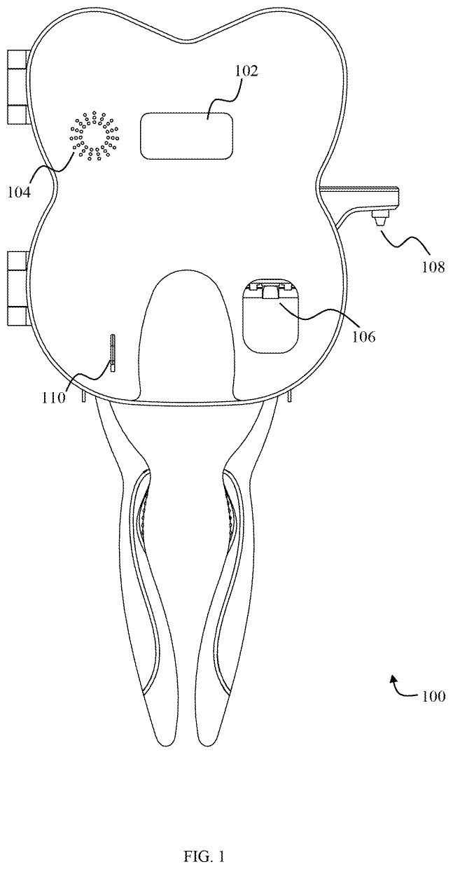

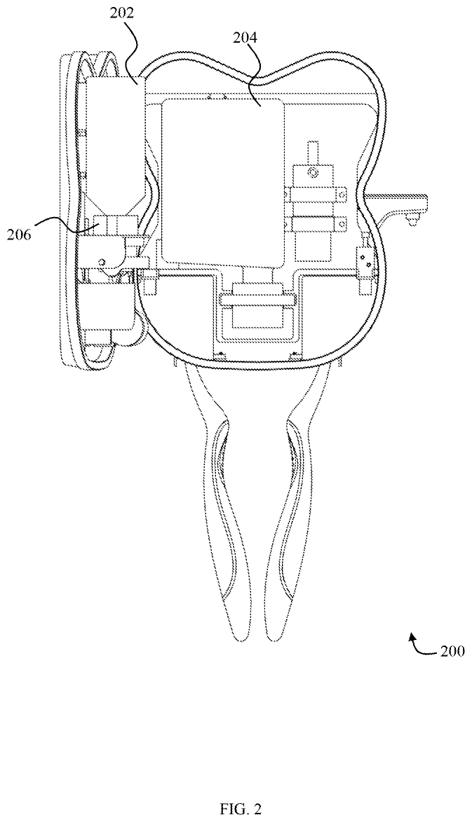

Referring to the figures, FIG. 1 is an exemplary depiction of the front view 100 of the apparatus for managing dental hygiene with its front lid in a closed configuration according to the embodiments of the present disclosure. The apparatus includes a display screen 102, a speaker 104, a toothpaste dispenser 106, a mouthwash dispenser 108, and a dental floss dispenser 110, as depicted in the figure. Each of the dispensers are connected to a container storing dental hygiene products. FIG. 2 is an exemplary depiction of the front view of the apparatus for managing dental hygiene with its front lid in an open configuration 200 according to the embodiments of the present disclosure. The first container storing the toothpaste is marked 202 and the second container storing the mouthwash is marked as 204.

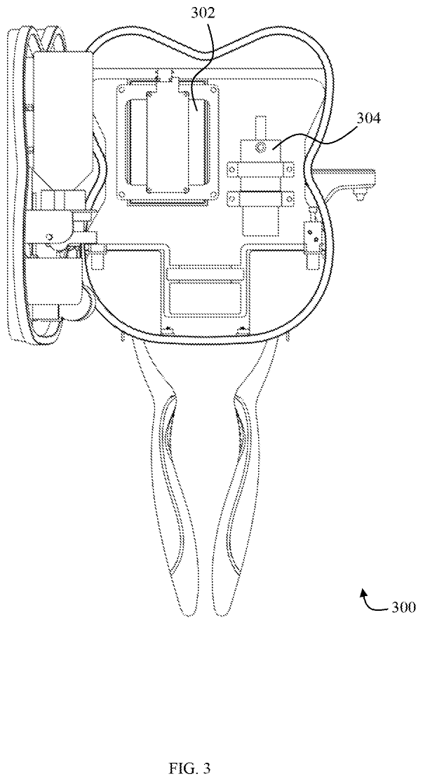

FIG. 3 is another exemplary depiction 300 of the front view of the apparatus for managing dental hygiene with its front lid in an open configuration with the mouthwash container removed according to the embodiments of the present disclosure. The apparatus is provided with a battery 302 and a pump 304 for supporting the dispensing action and other related functions.

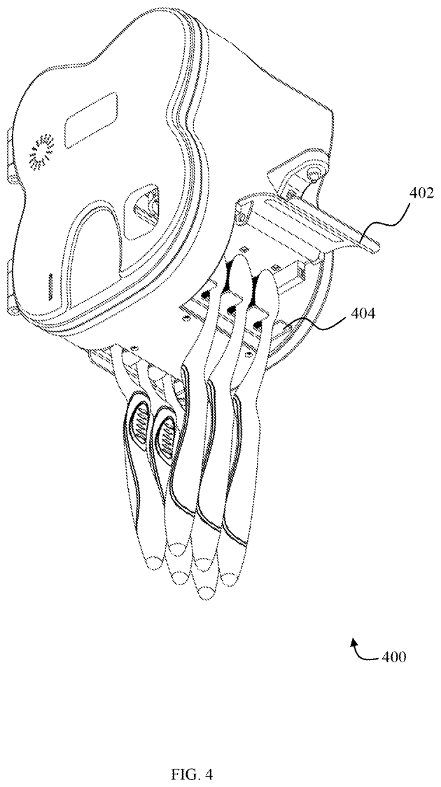

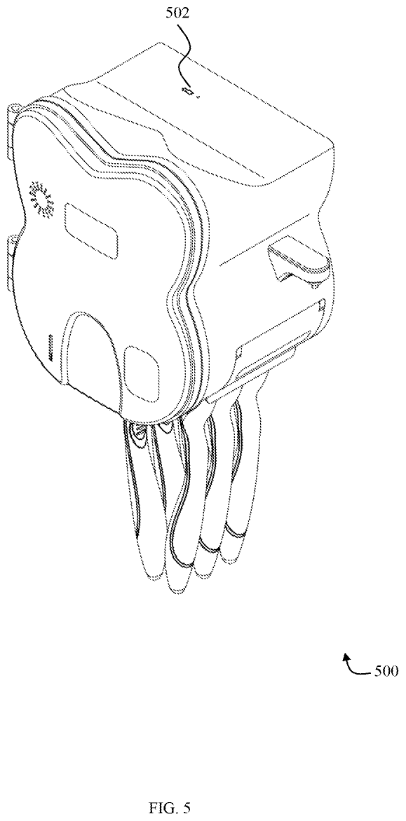

FIGS. 4 & 5 are exemplary isometric views 400 & 500 of the apparatus for managing dental hygiene according to the embodiments of the present disclosure. The side lid 402 locks the toothpaste holders 404 securely. The charging port 502 may be used for charging the battery 302.

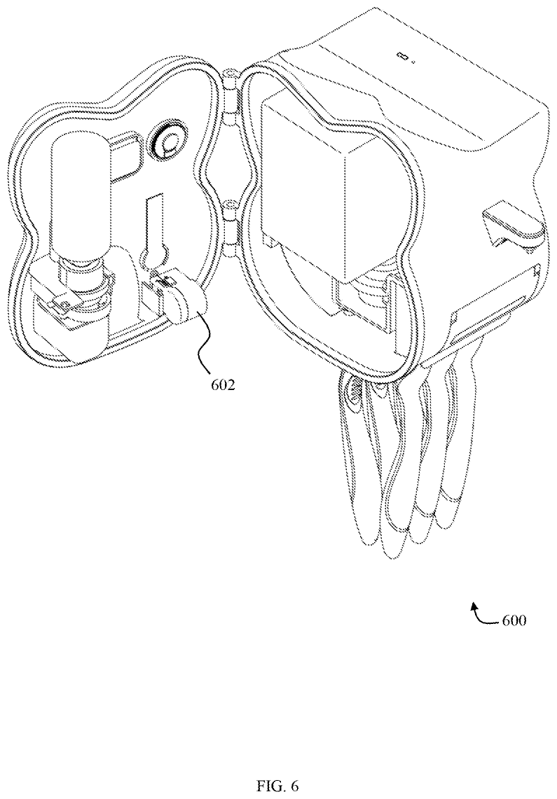

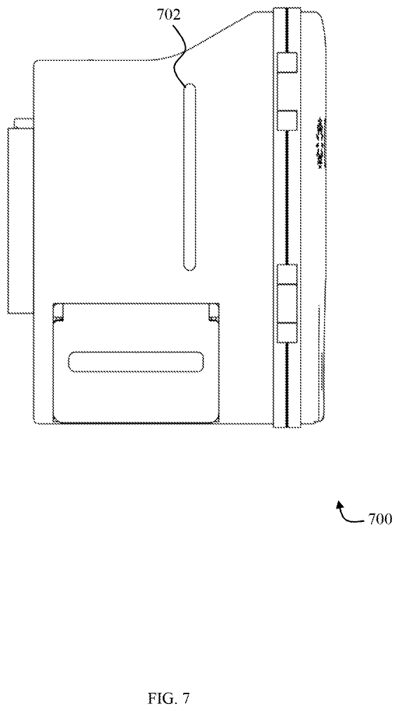

FIG. 6 is an exemplary isometric view 600 of the apparatus for managing dental hygiene with the front lid in an open configuration according to the embodiments of the present disclosure. The third container 602 stores dental floss and may be disposed via the dental floss dispenser 110. FIG. 7 is a left side view 700 of the apparatus for managing dental hygiene according to the embodiments of the present disclosure.

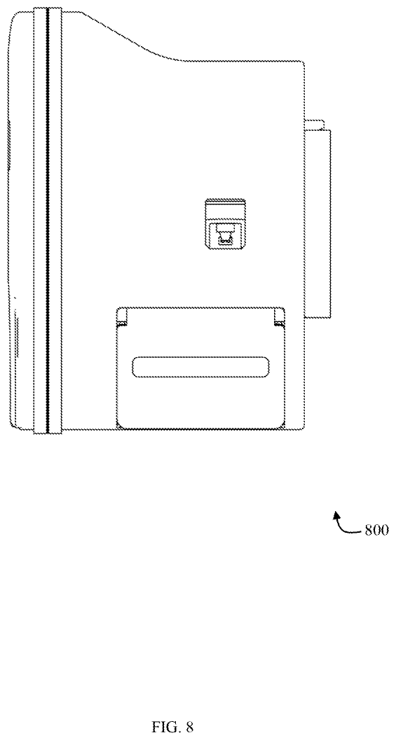

FIG. 8 is a right side view 800 of the apparatus for managing dental according to the embodiments of the present disclosure.

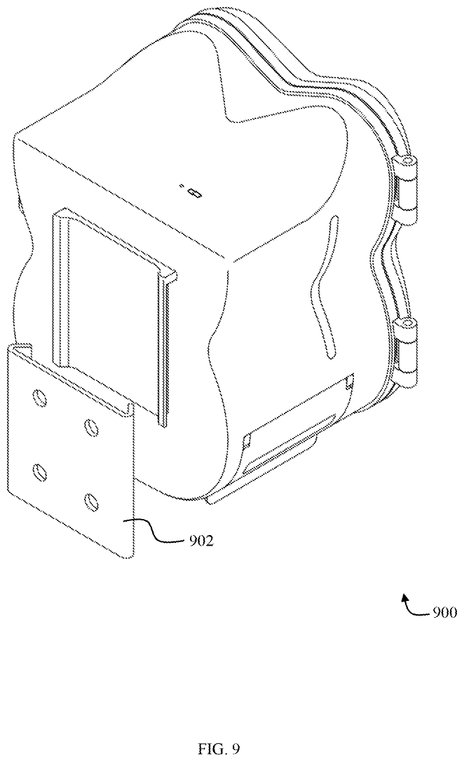

FIG. 9 is a rear side isometric view 900 of the apparatus for managing dental hygiene according to the embodiments of the present disclosure. A wall mount plate 902 may be provided on the rear side of the apparatus for mounting it to supporting structures including but not limited to walls, pillars, and the like.

The dental kit apparatus may be communicatively paired with a software application running on an electronic device such as a smartphone, a smart wearable device, a laptop, a tablet, and the like. The dental kit may be configured with one or more toothbrushes registered individually to each members of the family. When one toothbrush is ejected from the storage space, the amount of toothpaste required for that person automatically dispenses from the toothpaste dispenser and the total time taken for completing brushing is communicated with the software. The apparatus may automatically alarms to remind, especially children, to take care of their tooth. The parents can schedule the time frame for children to start and complete oral hygiene.

In addition, the dental kit apparatus may be provided with one or more storage spaces for keeping toothbrushes. The toothbrushes are sanitized or disinfected automatically by ultraviolet rays. The apparatus also have a floss dispenser that can be used to clean the gap between teeth. The suction feature of the toothpaste dispenser ensures every little drop of toothpaste is dispensed before a replacement is needed.

The apparatus may further allow storage of songs for playback via the inbuilt speakers 104 provided within the apparatus. This allows users to grab the attention of children while they are brushing their teeth. The display 102 may also be used to play attention seeking and educative content.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter.

What is claimed is:

1. An apparatus for dispensing oral hygiene products comprising:
a casing including:
a first container for storing toothpaste;
a first dispenser connected to the first container for enabling dispensing of toothpaste;
a second container for storing mouth wash;
a second dispenser connected to the second container for enabling dispensing of mouthwash;
a third container for storing dental floss;
a third dispenser connected to the third container for enabling dispensing of dental floss;
one or more pumps and motors for enabling dispensing of toothpaste, mouthwash, and dental floss via the first, the second, and the third dispensers;
a plurality of sensors configured to collect data related to amount of toothpaste, mouthwash, and dental floss dispensed by the apparatus during each dispensing action and timestamp of each dispensing action;
a microcontroller communicatively connected to the plurality of sensors, wherein the microcontroller analyzes the data collected by the plurality of sensors to:
determine a plurality of usage factors, wherein the usage factors include quantity of toothpaste, mouthwash and dental floss dispensed during each dispensing action, and amount of toothpaste, mouthwash and dental floss remaining in the containers;
communicating the plurality of usage factors to one or more users via a combination of display screen and a speaker provided on the casing or via an electronic device communicatively coupled to the apparatus.
